(19) United States
(12) Patent Application Publication
(10) Pub. No.: US 2014/0108738 A1
(43) Pub. Date: Apr. 17, 2014

(54) APPARATUS AND METHOD FOR DETECTING LARGE FLOW

(71) Applicant: ELECTRONICS AND TELECOMMUNICATIONS RESEARCH INSTITUTE, Daejeon-si (KR)

(72) Inventors: Jeong-Yun KIM, Daejeon-si (KR); Jinoo JOUNG, Seoul (KR)

(73) Assignee: ELECTRONICS AND TELECOMMUNICATIONS RESEARCH INSTITUTE, Daejeon-si (KR)

(21) Appl. No.: 14/040,963

(22) Filed: Sep. 30, 2013

(30) Foreign Application Priority Data
Oct. 11, 2012 (KR) 10-2012-0112855

(51) Int. Cl. G06F 12/08

(52) U.S. Cl. CPC G06F 12/0891
USPC 711/136; 711/133

(57) ABSTRACT

An apparatus and method for detecting a large flow are provided. The method includes: storing flow information corresponding to the received flow in a cache entry; determining whether or not there is a possibility to be determined that the flow corresponding to the flow information stored in an entry to be deleted from a cache by storing the flow information in the cache entry is a large flow; restoring the entry to be deleted in the cache according to a result of the possibility determination; inspecting a packet count of the entry in which the flow information is stored; and determining that the flow corresponding to the flow information stored in the corresponding entry is the large flow, if the result of the packet count inspection is greater than or equal to a preset threshold value.

### CROSS-REFERENCE TO RELATED APPLICATION

This application claims the benefit under 35 U.S.C. §119(a) of Korean Patent Application No. 10-2012-0112855, filed on Oct. 11, 2012, in the Korean Intellectual Property Office, the entire disclosure of which is incorporated herein by reference for all purposes.

### BACKGROUND

1. Field

The following description relates to a network management technique, and more particularly, to an apparatus and method for detecting a large flow.

2. Description of the Related Art

Recently, because of increasing of Internet users and advent of various application programs, network traffic is rapidly increasing in a large scale. In particular, a service transmitting a large file such as a peer-to-peer (P2P) and a web hard tends to cause a large amount of traffic, and due to this, a case in which a specific user occupies a portion of the entire network band alone for a specific time period may occur.

An elephant flow is a kind of large flow and refers to a network flow having a great number of bytes, and a mice flow refers to a flow having an attribute opposite to the elephant flow. Since the elephant flow and the mice flow variously coexist in actual network traffic and the elephant flow occupies a large portion of the entire band alone for a specific time period in a network link, a problem of the imbalance in sharing the entire band arises, and thereby a problem in terms of band management and billing arises.

Meanwhile, in order to detect the large flow, a least recently used (LRU) cache technique has conventionally been used. The LRU cache technique has a simple structure and an advantage that enables to find the large flow at a high speed in a limited magnitude of a storage space. However, there is a disadvantage that if a number of the mice flows enter a cache, the stored existing large flow may be quickly deleted from the cache. This disadvantage makes it difficult to detect the large flow correctly.

### SUMMARY

The following description relates to an apparatus and method capable of rapidly and correctly detecting a large flow even in a case in which a number of the mice flows enter the cache, by maintaining a basic structure of the LRU cache technique and holding the stored existing large flow in the cache.

In one general aspect, a method of detecting a large flow include: storing flow information corresponding to a received flow in a cache entry; determining whether or not there is a possibility to be determined that the flow corresponding to the flow information stored in an entry to be deleted from a cache by storing the flow information in the cache entry is a large flow; restoring the entry to be deleted in the cache according to a result of the possibility determination; inspecting a packet count of the entry in which the flow information is stored; and determining that the flow corresponding to the flow information stored in the corresponding entry is the large flow, if the result of the packet count inspection is greater than or equal to a preset threshold value.

In another general aspect, an apparatus for detecting a large flow include a cache configured to store flow information for a received flow; and a control unit configured to manage the cache based on an LRU algorithm, to determine whether or not the flow corresponding to the corresponding flow information is the large flow using the flow information stored in the cache, and to restore the flow information to be deleted from the cache according to whether or not there is a possibility to be determined that the flow corresponding to the flow information to be deleted from the cache is the large flow.

Other features and aspects will be apparent from the following detailed description, the drawings, and the claims.

### BRIEF DESCRIPTION OF THE DRAWINGS

FIG. 1 is a configuration diagram of a large flow detection apparatus according to one embodiment of the invention.

FIG. 2 is a detailed structure diagram of a cache 150 of FIG. 1.

FIG. 3 is a data structure diagram of an entry storing flow information according to one embodiment of the invention.

FIG. 4 is a flowchart illustrating a method of storing a network flow according to one embodiment of the invention.

FIG. 5A and FIG. 5B are flowcharts illustrating a method of determining a large flow in a landmark section 151 of FIG. 2.

FIG. 6 is a flowchart illustrating a method of processing a large flow in an elephant section 153 of FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

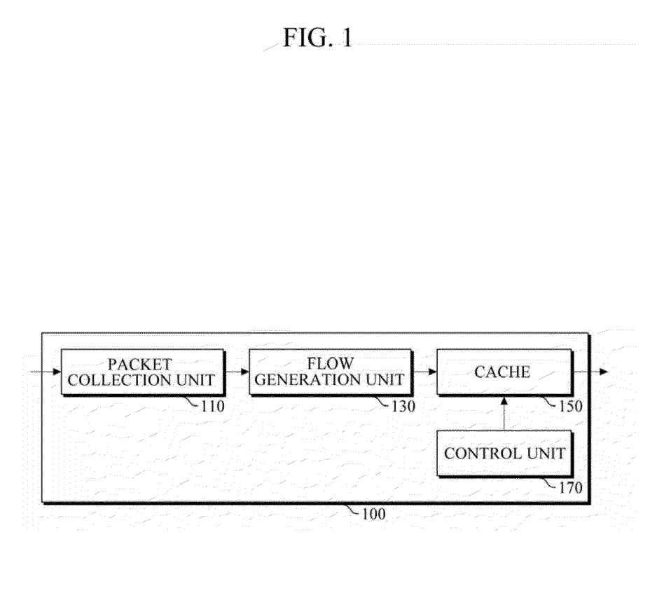

FIG. 1 is a configuration diagram of a large flow detection apparatus according to one embodiment of the invention.

Referring to FIG. 1, the large flow detection apparatus 100 according to one embodiment of the invention may include a packet collection unit 110 a flow generation unit 130 a cache 150 and a control unit 170.

The packet collection unit 110 collects a network packet.

The flow generation unit 130 generates a flow of the packet collected by the packet collection unit 110. For example, the flow generation unit 130 checks a protocol type of the collected packet, a source address, a source port, a destination address, and a destination port, and generates the flow of the corresponding packet according to whether or not five types of information coincide all. That is, the packet in which the five types of information coincide all is configured as one flow.

At this time, the generated flow may include the five types of information (the flow ID) and the number of the packets configuring of the corresponding flow or a packet count in which information for length of the packet is stored.

A cache 150 can temporarily store the flow information for the flow generated in the flow generation unit 130 according to the control of the control unit 170. At this time, the flow information is stored in an entry, and the entry may include flow ID information, packet count information of the corresponding flow, cycle flag information, and the like. A structure of the entry will be described in detail.

The cache 150 is managed based on an least recently used (LRU) algorithm according to the control of a control unit 170 and if all entries of the cache 150 store the flow information, the entry which is used least recently, in other words, which is not used for a long time is deleted together with flow information.

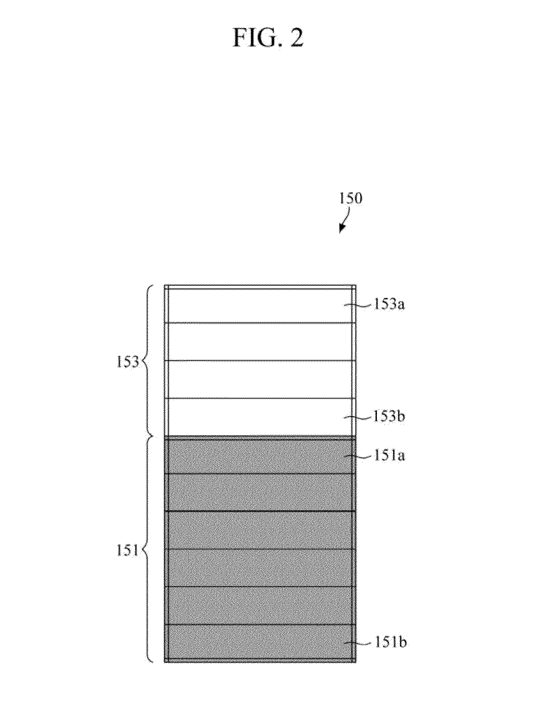

FIG. 2 is a detailed configuration diagram of the cache 150 of FIG. 1.

Referring to FIG. 2, the cache 150 is configured of a landmark section 151 and an elephant section 153. Further, each section is configured of a plurality of blocks and each block may include an entry. Each entry of each section stores one of the flow information, and each section is managed based on the LRU algorithm according to the control of the control unit 170.

The landmark section 151 can store the flow information for the flow generated in the flow generation unit 130. At this time, the flow information includes the flow ID information and the packet count information of the corresponding flow.

The cache 150 stores the flow information for the flow firstly generated in the flow generation unit 130 in the entry which presents in the top 151a of the landmark section. Thereafter, if a new flow is generated and then is transmitted to the cache 150, the cache 150 moves down by one block the entry which originally is in the top 151a of the landmark section, and generates a new entry in the top 151a of the landmark section and stores the flow information for the transmitted flow therein.

In this way, if the new flow is transmitted to the cache 150, the entry which originally is in the landmark section 151 moves down by one block and the entry which is in the bottom 151b of the landmark section is deleted.

If a flow hit occurs since the flow information for the flow transmitted to the cache 150 is stored in the landmark section 151, the packet count of the transmitted flow is added to the packet count of the entry which stores the corresponding flow information. Thereafter, if the added packet count is greater than or equal to a preset threshold value, it is determined that the flow having the flow information stored in the corresponding entry is the large flow, and the flow information stored in the corresponding entry is stored in the elephant section 153. On the contrary, if the added packet count is less than the preset threshold value, the corresponding entry is moved to the top 151a of the landmark section. At this time, it can be determined whether or not the flow information for the transmitted flow is stored in the landmark section 151 by comparing the flow IDs.

If a flow miss occurs since the flow information for the flow transmitted to the cache 150 is not stored in the landmark section 151, when the packet count of the transmitted flow is greater than or equal to the preset threshold value, it is determined that the corresponding flow is the large flow, and then the corresponding flow information is stored in the elephant section 153. On the contrary, if the packet count of the transmitted flow is less than the preset threshold value, the corresponding flow information is stored in the entry of the top 151a of the landmark section. If the flow information is stored in the entry which is originally in the top 151a of the landmark section, the entry which is originally in the top 151a of the landmark section moves down by one block, and a new entry is generated in the top 151a of the landmark section to store the transmitted flow information.

Further, if there is a possibility to be determined that the flow having the flow information stored in the entry which is originally in the bottom 151b of the landmark section is the large flow, the corresponding entry moves to the top 151a of the landmark section, and on the contrary, if there is no possibility to be determined as the large flow, the corresponding entry is deleted together with the flow information stored in the corresponding entry from the cache 150.

The elephant section 153 can store the flow information for the flow determined as the large flow.

The elephant section 153 stores initial information for the large flow moved from the landmark section 151 in the entry of the top 153a of the elephant section. Thereafter, if new large flow information is transmitted to the elephant section 153, the entry which is originally in the top 153a of the elephant section moves down by one block, and a new entry is generated in the top 153a of the elephant section and the transmitted large flow information is stored therein.

If the flow hit occurs since the large flow information transmitted to the elephant section 153 is stored in the elephant section 153, the packet count of the transmitted flow is added to the packet count of the entry which stores the corresponding large flow information, and the corresponding entry moves to the top 153a of the elephant section.

If the flow miss occurs since the large flow information transmitted to the elephant section 153 is not stored in the elephant section 153, the entry which originally is in the top 153a of the elephant section moves down by one block and a new entry is generated in the top 153a of the elephant section and stores the transmitted large flow information. At this time, the large flow information stored in the entry which is originally in the bottom 153b of the elephant section is transmitted outside and the corresponding entry is deleted.

The above description describes that the cache 150 controls an overall functions configured to store and processing the flow information, but all functions configured to store and processing the flow information are controlled in the control unit 170 and the cache 150 may simply perform only a function configured to store the flow information according to the control of the control unit.

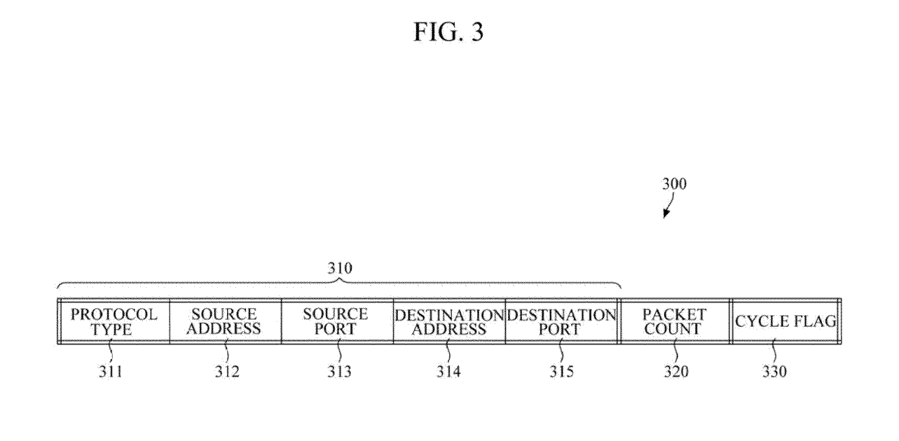

FIG. 3 is a data structure diagram of an entry which stores the flow information according to one embodiment of the invention.

Referring to FIG. 3, an entry 300 may include a flow ID 310 a packet count 320 and a cycle flag 330.

The flow ID 310 stores the network packet information configuring the flow, and the network packet information includes information such as a protocol type 311, a source address 312, a source port 313, a destination address 314, and a destination port 315. If the aforementioned packet information that the network packets have coincides all, the network packets configures one network flow.

The packet count 320 stores size information of the flow. The size of the network flow can be determined by number or length of the network packets. The packet count 320 is used so as to determine the large flow. That is, if the packet count 320 is greater than or equal to the preset threshold value, it is determined that the corresponding flow is the large flow. The cycle flag 330 stores information of the restored number of the entry which is not deleted according to the possibility to be determined that the flow having the flow information stored in the entry to be deleted from the cache 150 is the large flow. According to an exemplary description, if the flow is firstly transmitted to the cache 150 the flow information for the transmitted flow is stored in the entry, and at this time, the cycle flag 330 of the corresponding entry is initialized to ‘0’. If there is a possibility to be determined that the flow having the flow information stored in the entry which is about to be deleted from the cache 150 is the large flow, the corresponding entry adds 1 to the current value of the cycle flag 330 and restores the added value in the cache 150. At this time, if the cycle flag value exceeds the preset greatest flag value, the corresponding entry is not restored, but is deleted together with the flow information stored in the corresponding entry from the cache 150.

In the above description, though the entry of the landmark section 151 is not distinguished from the entry of the elephant section 153, but has the same structure, the entry of the elephant section 153 may not include the cycle flag 330.

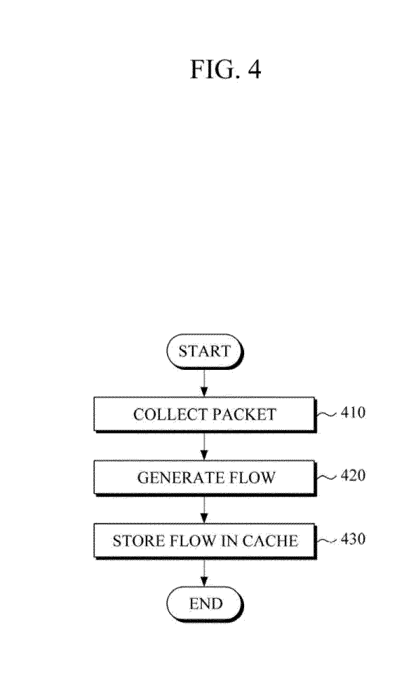

FIG. 4 is a flowchart illustrating a method of storing a flow according to one embodiment of the invention.

The method of storing the flow according to one embodiment of the present invention firstly collects a network packet in 410, and generates a flow of the corresponding packet using the collected packet in 420. For example, the flow generation unit 130 may check a protocol type of the collected packet, a source address, a source port, a destination address, and a destination port, and generate the flow of the corresponding packet according to whether or not the five types of information coincide all. That is, the packet in which the five types of information coincide all is configured as one flow. At this time, the generated flow may include the above-mentioned five types of information (the flow ID) and a packet count storing the information for the number or length of the packets configuring the corresponding flow.

Thereafter, the flow information for the generated flow is stored in the entry of the cache 150 in 430. At this time, the cache 150 is managed based on the LRU algorithm according to the control of the control unit 170.

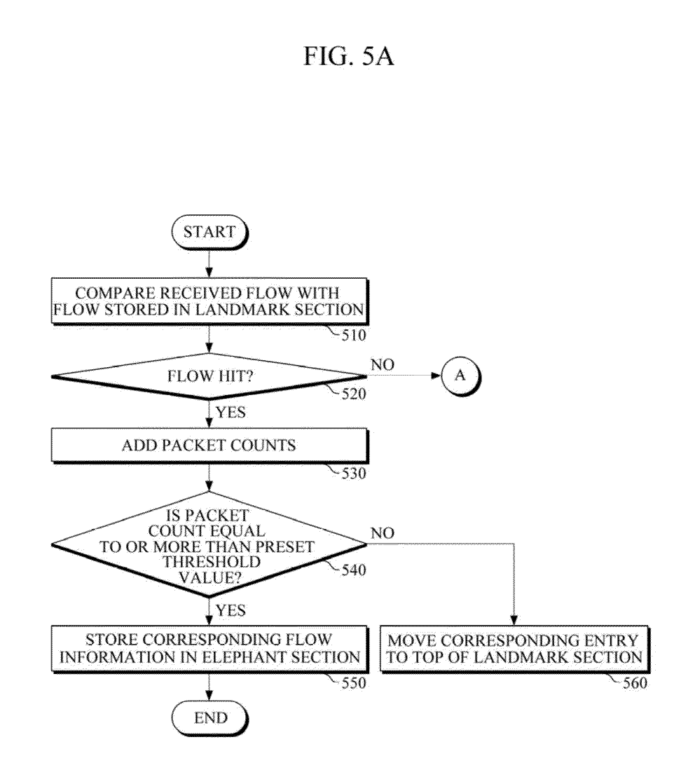

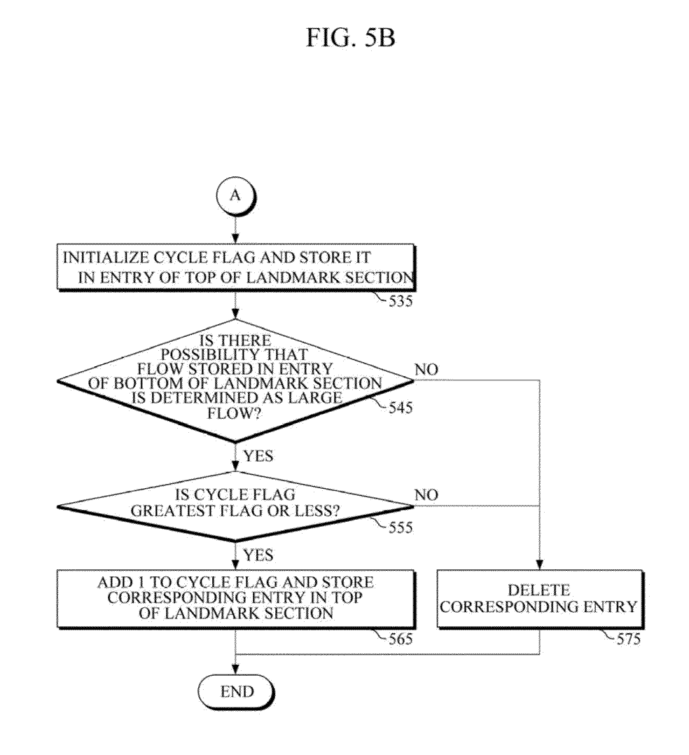

FIG. 5A and FIG. 5B are flowcharts illustrating a method of determining the large flow in the landmark section 151 of FIG. 2.

Referring to FIG. 5A and FIG. 5B, the method of determining the large flow in the landmark section 151 firstly compares a network flow received to the cache 150 with the network flow stored in the landmark section 151 in 510 and determines whether or not the flow hit occurs in 520. The flow hit occurs in a case in which the flow information for the received flow is stored in the landmark section 151, and whether or not the flow information presents can be determined by comparing the flow IDs 310.

In a case in which the flow hit occurs, the packet count of the received flow is added to the packet count 320 of the entry which stores the corresponding flow information in 530 whether or not the added packet count is greater than or equal to the preset threshold value is determined in 540 if the added packet count is greater than or equal to the preset threshold value, it is determined that the flow having the corresponding flow information is the large flow, and then the corresponding flow information is stored in the elephant section 153 in 550. If the added packet count is less than the preset threshold value, the corresponding entry is moved to the top 151a of the landmark section.

On the contrary, if the flow hit does not occur, the flow information for the received flow is stored in the entry which is in the top 151a of the landmark section after initializing the cycle flag in 535. At this time, if the entry which is originally in the top 151a of the landmark section stores the flow information, the entry which is originally in the top 151a of the landmark section moves down by one block, a new entry is generated in the top 151a of the landmark section, and then the flow information for the received flow is stored. Further, like the entry which originally is in the top 151a of the landmark section, all of the entries which are originally in the landmark section 151 move down by one block.

Thereafter, it is determined whether or not there is a possibility to be determined that the flow having the flow information stored in the entry, which originally is in the bottom 151b of the landmark section, is the large flow in 545. At this time, the possibility determination can be made by analyzing the packet count 320 of the corresponding entry. For example, if the packet count 320 is greater than or equal to a possibility determination index, it is determined that there is a possibility to be determined that the flow having the flow information stored in the corresponding entry is the large flow, and if it is less than that, it can be determined that there is no possibility. At this time, the possibility determination index is preset to a smaller value than the preset threshold value which is compared when determining the large flow by a user.

As a result of the possibility determining operation in 545, if there is a possibility to be determined that the flow having the flow information stored in the entry which is in the bottom 151b of the landmark section is the large flow, it is determined whether or not the cycle flag 330 of the corresponding entry is less than or equal to the greatest flag in 555, and if the cycle flag 330 is less than or equal to the greatest flag, 1 is added to the cycle flag 330 of the corresponding entry and the corresponding entry moves to the top 151a of the landmark section and thereby the added value is stored therein in 565. At this time, the greatest flag is preset by the user.

On the contrary, if there is no possibility to be determined that the flow having the flow information stored in the entry which is in the bottom 151b of the landmark section is the large flow or if the cycle flag exceeds the preset greatest flag even though there is a possibility, the corresponding entry is deleted together with the stored flow information from the cache 150 in 575.

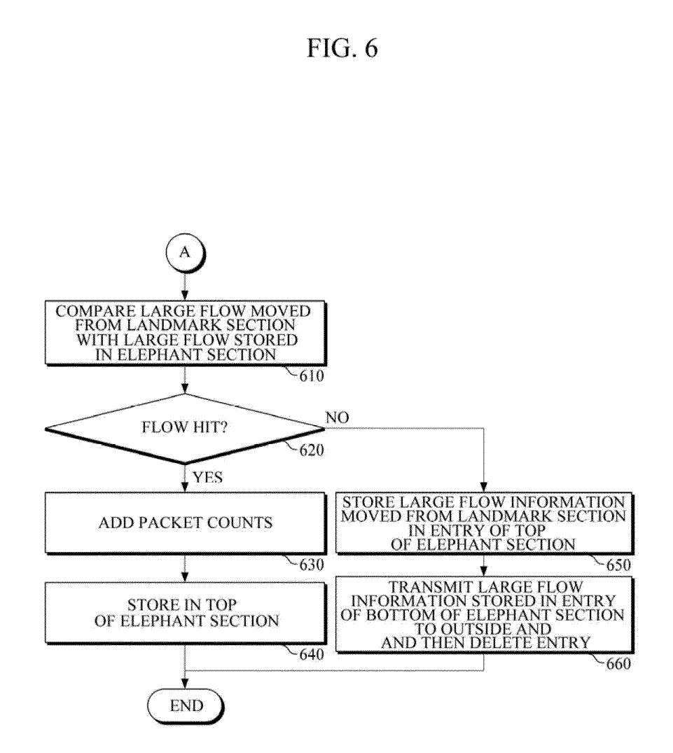

FIG. 6 is a flowchart illustrating a method of processing the large flow in the elephant section 153.

Referring to FIG. 6, the method of storing and processing the large flow in the elephant section 153 firstly compares the large flow moved from the landmark section 151 with the large flow stored in the elephant section 153 in 610 and determines whether or not the flow hit occurs in 620. The flow hit occurs when the flow information for the large flow moved from the landmark section 151 is stored in the elephant section 153, and whether or not the flow information presents can be determined by comparing the flow IDs 310.

If the flow hit occurs, the packet count of the large flow moved from the landmark section 151 is added to the packet count 320 of the entry which stores the corresponding large flow information in 630 and the corresponding entry is moved to the top 153a of the elephant section in 640.

On the contrary, if the flow hit does not occur, the large flow information moved from the landmark section 151 is stored in the entry which is the top 153a of the elephant section in 650. At this time, if the entry which originally is in the top 153a of the elephant section stores the large flow information, the entry which originally is in the top 153a of the elephant section moves down by one block, a new entry is generated in the top 153a of the elephant section, and the large flow information moved from the landmark section 151 is stored therein. Further, all of entries which originally are in the elephant section 153 move down by one block like the entry which originally is in the top 153a of the elephant section.

Thereafter, according to the LRU algorithm, the large flow information stored in the entry which originally is in the bottom 153b of the elephant section is transmitted outside and the corresponding entry is deleted in 660.

It is also possible to implement the present invention in a computer readable recording medium in a form of codes readable by a computer. At this time, the computer readable recording medium includes all kinds of recording mediums in which data readable by a computer system is stored.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of detecting a large flow, comprising:
storing flow information corresponding to a received flow in a cache entry;
determining whether or not there is a possibility to be determined that the flow corresponding to the flow information stored in an entry to be deleted from a cache by storing the flow information in the cache entry is a large flow;
restoring the entry to be deleted in the cache according to a result of the possibility determination;
inspecting a packet count of the entry in which the flow information is stored; and
determining that the flow corresponding to the flow information stored in the corresponding entry is the large flow, if the result of a packet count inspection is greater than or equal to a preset threshold value.

2. The method according to claim 1, further comprising:
generating a flow of a collected packet using information such as a protocol type of the collected packet, a source address, a source port, a destination address, and a destination port.

3. The method according to claim 2,
wherein the flow information of the generated flow further includes a packet count.

4. The method according to claim 1,
wherein the cache is divided into a landmark section configured to store the received flow information and an elephant section configured to store the determined large flow information.

5. The method according to claim 4,
wherein the landmark section and the elephant section are managed based on an LRU algorithm.

6. The method according to claim 4,
wherein the possibility determining includes determining whether or not there is a possibility to be determined that the flow corresponding to the flow information stored in the entry which is in the bottom of the landmark section is the large flow.

7. The method according to claim 6, further comprising: after the possibility determining,
inspecting a cycle flag of the corresponding entry, if there is a possibility to be determined that the flow corresponding to the flow information stored in the entry which is in the bottom of the landmark section is the large flow; and
deleting the entry which is in the bottom of the landmark section together with the stored flow information, if the result of the cycle flag inspection is larger than the preset greatest flag.

8. The method according to claim 4, further comprising: after determining the large flow,
storing the flow information for the determined large flow in the elephant section.

9. A large flow detection apparatus, comprising:
a cache configured to store flow information for a received flow; and
a control unit configured to determine whether or not the flow corresponding to the corresponding flow information is the large flow using the flow information stored in the cache and to restore the flow information to be deleted from the cache according to whether or not there is a possibility to be determined that the flow corresponding to the flow information to be deleted from the cache is the large flow.

10. The large flow detection apparatus according to claim 9, wherein the cache includes a landmark section configured to store the flow information of the received flow and an elephant section configured to store the flow information of the determined large flow.
